(19) United States
(12) Patent Application Publication
(10) Pub. No.: US 2025/0312759 A1
(43) Pub. Date: Oct. 9, 2025

(54) HYDROGEN GENERATION APPARATUS

(71) Applicant: CANON KABUSHIKI KAISHA, Tokyo (JP)

(72) Inventors: SHUNSUKE TSUDA, Tokyo (JP); SHOKO FUJIWARA, Ibaraki (JP); KEIJI KARUBE, Ibaraki (JP); AKIKO TOMINAGA, Kanagawa (JP); KENJI UTSUNOMIYA, Tokyo (JP); TSUYOSHI KUROKI, Kanagawa (JP)

(21) Appl. No.: 19/241,158

(22) Filed: Jun. 17, 2025

Related U.S. Application Data
(63) Continuation of application No. PCT/JP2023/044541, filed on Dec. 13, 2023.

(30) Foreign Application Priority Data
Dec. 20, 2022 (JP) 2022-203050

(51) Int. Cl. B01J 8/10; B01J 8/00; C01B 3/06

(52) U.S. Cl. CPC B01J 8/10; B01J 8/003; C01B 3/065; B01J 2208/00654; B01J 2208/00752; C01B 2203/1205; C01B 2203/169

(57) ABSTRACT

A hydrogen generation apparatus applies a solid hydrogen carrier on a surface of a conveyance belt by an application apparatus, and ejects, by an ejection apparatus, a liquid containing water onto the hydrogen carrier applied on the surface. Then, hydrogen generated by a reaction between the hydrogen carrier and the liquid on the surface is collected by a hydrogen collection apparatus. Byproduct generated by the reaction between the hydrogen carrier and the liquid on the surface is collected by a byproduct collection apparatus. A regulation member regulates the thickness of the hydrogen carrier applied on the surface of the conveyance belt by the application apparatus.

### CROSS-REFERENCE TO RELATED APPLICATIONS

This application is a Continuation of International Patent Application No. PCT/JP2023/044541, filed Dec. 13, 2023, which claims the benefit of Japanese Patent Application No. 2022-203050, filed Dec. 20, 2022, both of which are hereby incorporated by reference herein in their entirety.

### BACKGROUND

### Field of the Technology

The present disclosure relates to a hydrogen generation apparatus that generates hydrogen by using, as a raw material, a hydrogen carrier having a nature of generating hydrogen when a water-containing liquid is poured thereon.

### Description of the Related Art

As a hydrogen generation apparatus, an apparatus that supplies water and a solvent to sodium borohydride and generates hydrogen by hydrolysis of the sodium borohydride is proposed (for example, Patent Literature 1).

### CITATION LIST

### Patent Literature

Patent Literature 1: Japanese Patent Application Laid-Open No. 2017-114708

### SUMMARY

Here, as a configuration of generating hydrogen by supplying a water-containing liquid to a hydrogen carrier such as sodium borohydride, a configuration in which the hydrogen carrier is applied on the surface of the conveyance belt and the liquid is supplied to this hydrogen carrier can be considered. In the case of this configuration, if the thickness of the hydrogen carrier on the surface of the conveyance belt is uneven, the progress of reaction caused by the supply of the liquid also becomes uneven.

The present disclosure provides a hydrogen generation apparatus that easily promotes a reaction between a hydrogen carrier and a water-containing liquid.

According to a first aspect of the present disclosure, a hydrogen generation apparatus includes a conveyance belt; an application apparatus configured to apply a solid hydrogen carrier on a surface of the conveyance belt; an ejection apparatus configured to eject a liquid containing water onto the hydrogen carrier applied on the surface of the conveyance belt; a hydrogen collection apparatus configured to collect hydrogen generated by a reaction between the hydrogen carrier and the liquid on the surface of the conveyance belt; a byproduct collection apparatus configured to collect a byproduct generated by the reaction between the hydrogen carrier and the liquid on the surface of the conveyance belt; and a regulation member for regulating a thickness of the hydrogen carrier applied on the surface of the conveyance belt by the application apparatus.

According to a second aspect of the present disclosure, a hydrogen generation apparatus includes a conveyance belt; an application apparatus configured to apply a solid hydrogen carrier on a surface of the conveyance belt; an ejection apparatus configured to eject a liquid containing water onto the hydrogen carrier applied on the surface of the conveyance belt; a hydrogen collection apparatus configured to collect hydrogen generated by a reaction between the hydrogen carrier and the liquid on the surface of the conveyance belt; and a byproduct collection apparatus configured to collect a byproduct generated by the reaction between the hydrogen carrier and the liquid on the surface of the conveyance belt, wherein the application apparatus includes a supply roller configured to bear the hydrogen carrier and supply the hydrogen carrier onto the surface of the conveyance belt, and a roller-side regulation member configured to regulate a thickness of the hydrogen carrier borne on the supply roller.

According to a third aspect of the present disclosure, a hydrogen generation apparatus includes a conveyance belt; an application apparatus configured to apply a solid hydrogen carrier on a surface of the conveyance belt; an ejection apparatus configured to eject a liquid containing water onto the hydrogen carrier applied on the surface of the conveyance belt; a hydrogen collection apparatus configured to collect hydrogen generated by a reaction between the hydrogen carrier and the liquid on the surface of the conveyance belt; and a byproduct collection apparatus configured to collect a byproduct generated by the reaction between the hydrogen carrier and the liquid on the surface of the conveyance belt, wherein the application apparatus includes a supply roller configured to bear the hydrogen carrier and supply the hydrogen carrier onto the surface of the conveyance belt, and wherein the supply roller is disposed to oppose the surface of the conveyance belt with a predetermined gap therebetween or be in contact with the surface, and regulates a thickness of the hydrogen carrier applied on the surface while supplying the hydrogen carrier onto the surface.

Features of the present disclosure will become apparent from the following description of embodiments with reference to the attached drawings.

### BRIEF DESCRIPTION OF THE DRAWINGS

FIG. 1 is a schematic configurational section view of a hydrogen generation apparatus according to a first embodiment.

FIG. 2 is a control block diagram of the hydrogen generation apparatus according to the first embodiment.

FIG. 3 is a schematic configurational section view illustrating an enlarged view of a powder application apparatus in the hydrogen generation apparatus according to the first embodiment.

FIG. 4 is a schematic configurational section view illustrating an enlarged view of a powder application apparatus in a hydrogen generation apparatus according to a second embodiment.

FIG. 5 is a schematic configurational section view illustrating an enlarged view of a powder application apparatus in a hydrogen generation apparatus according to a third embodiment.

### DESCRIPTION OF THE EMBODIMENTS

### First Embodiment

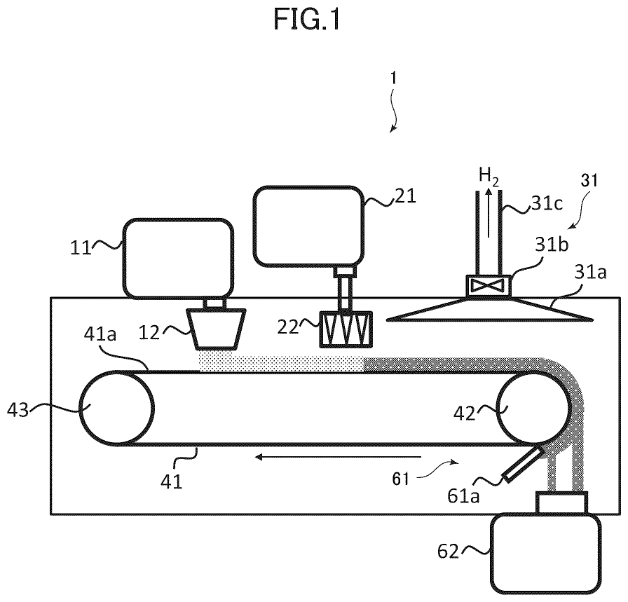

A first embodiment will be described with reference to FIGS. 1 to 3. First, hydrogen is attracting attention as an energy source to replace fossil fuel. This is because, unlike fossil fuel, when being combusted, hydrogen does not generate, for example, carbon dioxide that is a kind of a greenhouse gas that causes global warming. One example of a system that uses hydrogen as an energy source and that is put into practical use is a fuel cell vehicle. A fuel cell vehicle is an automobile that generates power by using hydrogen as a raw material and moves by driving an electric motor by the generated power. Most of fuel cell vehicles store hydrogen serving as an energy source in a hydrogen tank, and generates power by charging the hydrogen discharged from the hydrogen tank into a fuel cell. In the hydrogen tank, hydrogen is stored in a compressed state at a high pressure such as 70 MPa (700 times as high as atmospheric pressure).

Hydrogen serving as an energy source has a problem that the energy density thereof is low. The volume energy density of hydrogen is about 1/3000 of that of gasoline, and energy of only about ⅕ of that of gasoline of the same volume can be obtained even if the hydrogen tank of 70 MPa is used. Therefore, typically, a fuel cell vehicle including a hydrogen tank is required to be charged with energy more frequently than an automobile using gasoline.

Therefore, as a material (that is, a hydrogen carrier) that can carry hydrogen at a higher energy density than a hydrogen tank, various materials are considered. For example, ammonia, methylcyclohexane, and the like are known as hydrogen carriers, and transporting a hydrogen carrier instead of hydrogen itself and taking out hydrogen from the hydrogen carrier at use are performed.

Among hydrogen carrier materials like these, metal hydrides such as sodium borohydride from which hydrogen can be easily taken out by pouring water thereon are widely known. As a method of obtaining hydrogen by hydrolysis of sodium borohydride, a method of dissolving sodium borohydride in water and using it as an aqueous solution is known. However, in the case of this method, there is a problem that more water than an amount required in the theory represented by the reaction formula is required, and thus the substantial volume energy density is reduced.

Therefore, in the present embodiment, hydrogen is generated by pouring a water-containing liquid on a solid hydrogen carrier by a hydrogen generation apparatus configured as described below. In addition, a byproduct generated by the reaction between the hydrogen carrier and the liquid is collected. The byproduct can be restored into the hydrogen carrier.

### [Hydrogen Generation Apparatus]

A schematic configuration of hydrogen generation apparatus 1 will be described by using FIG. 1. The hydrogen generation apparatus 1 of the present embodiment is an apparatus that places a hydrogen carrier that is solid (powder in the present embodiment) on the conveyance belt 41, ejects a water-containing liquid thereonto, reacts the hydrogen carrier with the water-containing liquid on the conveyance belt 41, and thus generates hydrogen. The hydrogen generation apparatus 1 mainly includes the conveyance belt 41, a powder application apparatus 12 serving as an application apparatus, a liquid ejection apparatus 22 serving as an ejection apparatus, a hydrogen collection apparatus 31, and a byproduct collection apparatus 61.

The conveyance belt 41 rotates in an arrow direction of FIG. 1. The powder application apparatus 12 receives supply of hydrogen carrier from a hydrogen carrier storage case 11 storing a hydrogen carrier that is powder, and applies the hydrogen carrier on a surface 41a of the conveyance belt 41. The liquid ejection apparatus 22 is disposed downstream of the powder application apparatus 12 in the rotational direction of the conveyance belt 41, receives supply of the liquid from a liquid storage case 21 storing the water-containing liquid, and ejects the liquid onto the hydrogen carrier applied on the surface 41a of the conveyance belt 41.

The hydrogen collection apparatus 31 is disposed downstream of the liquid ejection apparatus 22 in the rotational direction of the conveyance belt 41, and collects hydrogen generated by the reaction between the hydrogen carrier and the liquid on the surface 41a of the conveyance belt 41. The byproduct collection apparatus 61 collects the byproduct generated by the reaction between the hydrogen carrier and the liquid on the surface 41a of the conveyance belt 41. The byproduct mentioned herein refers to a product other than hydrogen generated by the reaction between the hydrogen carrier and the liquid.

The hydrogen generation apparatus 1 can perform, on the conveyance belt 41, a series of steps such as generating hydrogen by the reaction between the hydrogen carrier and the water-containing liquid, and collecting the byproduct after the reaction. Therefore, an advantage that hydrogen can be generated continuously, stably, and in a long term is realized in a compact apparatus configuration.

The operation of the hydrogen generation apparatus 1 is as follows. First, the conveyance belt 41 starts operating, and when the conveyance speed of the conveyance belt 41 has become stable at a predetermined speed and the surface temperature of the conveyance belt 41 has reached a set temperature, the powder application apparatus 12 starts operating, and applies the hydrogen carrier on the conveyance belt 41. The liquid is ejected from the liquid ejection apparatus 22 at a timing when the hydrogen carrier comes under the liquid ejection apparatus 22, thus the reaction between the hydrogen carrier and the liquid is started, and the generated hydrogen is collected by the hydrogen collection apparatus 31.

Then, the byproduct generated after the reaction between the hydrogen carrier and the water-containing liquid is conveyed to the byproduct collection apparatus 61, and the byproduct is collected and sent to a byproduct collection case 62 by the byproduct collection apparatus 61. Next, each constituent element will be described in detail.

### Hydrogen Carrier

The “hydrogen carrier” mentioned in the present embodiment is not particularly limited as long as the hydrogen carrier is a solid hydrogen carrier that generates hydrogen when a water-containing liquid is poured thereon. For example, solid metal hydrides such as sodium borohydride, potassium borohydride, lithium borohydride, zinc borohydride, aluminum lithium hydride, aluminum sodium hydride, aluminum magnesium hydride, aluminum calcium hydride, magnesium hydride, lithium hydride, sodium hydride, and calcium hydride, and metal powder such as aluminum, zinc, calcium, and magnesium can be used solely or in combination. In addition, an additive such as a reaction accelerator or a desiccant may be contained.

In addition, although the hydrogen carrier of the present embodiment is preferably a solid such as powder or granule, but solids such as sheets, pellets, and pastes are also usable. As the powder, one having a particle diameter of about 10 μm or more and 10 mm or less, and one having a particle diameter of 10 μm or more and 3 mm or less, and further one having a particle diameter of 10 μm or more and 100 μm or less are more preferable. In addition, in the case of use in the form of a sheet or a pellet, it is preferable to perform surface roughening, pore-forming treatment, or the like to increase the surface area and increase the contact area with the water-containing liquid from the viewpoint of enhancing the reactivity with the water-containing liquid.

In the present embodiment, a powder of sodium borohydride having an average particle diameter of 50 μm is used as the solid hydrogen carrier. To be noted, the average particle diameter of the solid hydrogen carrier is not limited to this. The sodium borohydride powder reacts with water to generate hydrogen. The reacted sodium borohydride turns into a powder of sodium metaborate that is a byproduct. This reaction is expressed as follows by a chemical formula.

NaBH₄ (sodium borohydride)+2H₂O (water)→NaBO₂ (sodium metaborate)+4H₂ (hydrogen) (1)

This reaction (chemical formula (1)) is known to be promoted by a Raney catalyst formed from metal such as nickel, cobalt, or copper, and an acidic solution such as citric acid or acetic acid.

### [Water-Containing Liquid]

The “water-containing liquid” mentioned in the present embodiment is not particularly limited as long as the liquid reacts with the hydrogen carrier and generates hydrogen when poured. That is, the water-containing liquid may be a simple of water. In addition, two or more kinds of water-containing liquids may be prepared. By preparing two or more kinds of water-containing liquids, the generation speed of hydrogen can be adjusted.

The water-containing liquid can include a water-soluble organic solvent. Examples thereof can include alcohols, polyalkylene glycols, glycol ethers, nitrogen-containing compounds, and sulfur-containing compounds. Two kinds or more selected from these can be also used in mixture. By containing a water-soluble organic solvent, adjustment of the surface tension, adjustment of the boiling point and melting point of the water-containing liquid can be performed to optimize the reaction with the hydrogen carrier.

A surfactant can be added to the water-containing liquid. By using the surfactant, the surface tension of the water-containing liquid can be reduced, the contact area with the hydrogen carrier can be increased, and thus efficient reaction can be performed.

The water-containing liquid can contain a water-soluble acidic substance. The acidic substance functions as a positive catalyst in the reaction between the water-containing liquid and the hydrogen carrier. By adjusting the amount of the liquid containing the acidic substance, the generation speed of hydrogen can be adjusted. Particularly, by setting the pH obtained by the water-containing liquid and the hydrogen carrier to be lower than 9.0, the hydrogen generation speed can be increased. Examples thereof include various acids such as chloric acid, sulfuric acid, nitric acid, boric acid, and organic acids, but are not limited to these.

The water-containing liquid can include a water-soluble basic substance. The basic substance functions as a negative catalyst in the reaction between the water-containing liquid and the hydrogen carrier. By adjusting the amount of the liquid containing the basic substance, the generation speed of hydrogen can be adjusted. Particularly, by setting the pH obtained by the water-containing liquid and the hydrogen carrier to be equal to or higher than 9.0, the hydrogen generation speed can be reduced. Examples thereof include bases such as sodium hydrate, potassium hydrate, and ammonia water, but are not limited to these.

The water-containing liquid can include a buffer liquid. The buffer liquid functions to suppress pH fluctuation in the reaction between the water-containing liquid and the hydrogen carrier. By adjusting the amount of the liquid containing the buffer liquid, the generation speed of hydrogen can be adjusted. Examples thereof include various buffer liquids such as a phosphoric acid buffer liquid, a glycine buffer liquid, a Good's buffer liquid, a Tris buffer liquid, and an ammonia buffer liquid, but are not limited to these.

The water-containing liquid may contain various additives such as a defoaming agent, a pH adjuster, a viscosity adjuster, a rust inhibitor, an antiseptic agent, an antifungal agent, an antioxidant, and an anti-reduction agent in addition to the components described above if necessary.

### [Conveyance Belt]

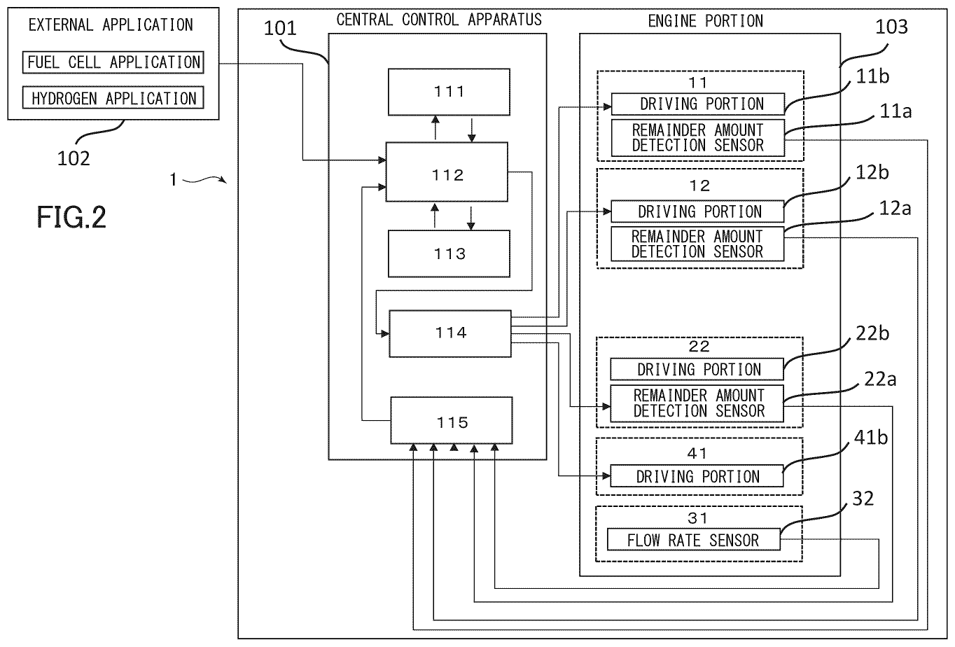

The conveyance belt 41 serving as a conveyance member is an endless belt, and is capable of conveying the solid hydrogen carrier. The conveyance belt 41 is stretched by the driving roller 42 and the driven roller 43. The driving roller 42 is fixed, the driven roller 43 is subjected to a force pushing out the driven roller 43 to the front surface side of the conveyance belt by the urging force of an unillustrated urging spring, and a certain tension is applied to the conveyance belt 41 due to this force. In addition, the driving roller 42 is coupled to a driving portion 41b (see FIG. 2) such as a motor, and thus the conveyance belt 41 circulates (i.e. rotates) in a clockwise direction (arrow direction) of FIG. 1 as a result of the driving roller 42 being rotationally driven by the driving portion 41b. Although the conveyance belt 41 is supported by two rollers in the present embodiment, there is no problem if, for example, the conveyance belt 41 is supported by a plurality of rollers such as three rollers.

In either case, the conveyance belt 41 is provided such that a stretched surface stretched by two rollers (the driving roller 42 and the driven roller 43 in the present embodiment), that is, the surface 41a described above is oriented in approximately the horizontal direction. In addition, the surface 41a is a surface facing up, and the powder application apparatus 12, the liquid ejection apparatus 22, and the hydrogen collection apparatus 31 disposed above the conveyance belt 41 oppose the surface 41a.

The conveyance belt 41 configured in this manner includes a mechanism that functions to convey the hydrogen carrier applied on the conveyance belt 41 by the powder application apparatus 12 toward the downstream side in the rotational direction in the order of the liquid ejection apparatus 22 and the hydrogen collection apparatus 31. After this, the byproduct after the reaction is conveyed further downstream to the byproduct collection apparatus 61.

The conveyance belt 41 is preferably imparted with electrical conductivity from the viewpoint of not causing static electricity, and may be formed from metal or resin. In the case of metal, aluminum, iron, copper, Ni, stainless steel (SUS), and the like can be used. In addition, in the case of resin, a resin having a high glass transition temperature is preferable from the viewpoint of heat resistance, and for example, engineering plastics having high heat resistance and high durability such as polyimide, polyamideimide, and polyether ether ketone are preferable. In addition, in the case of resin not having electrical conductivity, it is preferable that the resin contains an antistatic agent such as carbon black to have electrical conductivity imparted. In addition, it is preferable that the thickness of the conveyance belt 41 is about 30 μm or more and 200 μm or less from the viewpoint of thermal conductivity. In the present embodiment, an endless belt formed from resin imparted with electrical conductivity that is polyimide containing carbon is used as the conveyance belt 41.

The conveyance speed (rotational speed) of the conveyance belt 41 is a predetermined speed set for each kind of the hydrogen carrier and the water-containing liquid that are used. In addition, it is preferable that the conveyance speed is adjustable as appropriate in accordance with the required hydrogen amount. As a result of this, in the case where, for example, the amount of hydrogen collected by the hydrogen collection apparatus 31 has not reached a planned amount, the hydrogen generation amount can be adjusted by, for example, appropriately adjusting the conveyance speed in accordance with the hydrogen amount measured by a flow rate sensor 32 (see FIG. 2) or the like that measures the flow rate of the hydrogen collected by the hydrogen collection apparatus 31.

### [Powder Application Apparatus]

The powder application apparatus 12 is an apparatus that receives supply of the hydrogen carrier from the hydrogen carrier storage case 11 and applies the hydrogen carrier on the conveyance belt 41. There is no problem if the thickness of the hydrogen carrier applied on the conveyance belt 41 is about 50 μm or more and 3 mm or less, but it is preferable that the thickness is set to 50 μm or more and 500 μm or less to improve the reactivity with the water-containing liquid.

In addition, the hydrogen carrier storage case 11 serving as a hydrogen carrier replenishment container stores hydrogen carrier (hydrogen carrier for replenishment) for replenishment of the storage portion of the powder application apparatus 12. The hydrogen carrier storage case 11 is attachable to and detachable from the powder application apparatus 12. That is, the hydrogen carrier storage case 11 is replaceable.

The powder application apparatus 12 applies the hydrogen carrier on the conveyance belt 41 by only the gravity or by the gravity and an external force from rotation of a paddle, a roller, a brush roller, a screw fin, or the like therein. The supply of the hydrogen generating substance to the conveyance belt 41 becomes stagnant when the powder application apparatus 12 becomes empty, and therefore it is preferable that a sensor that detects the remainder amount of the hydrogen carrier is provided in the powder application apparatus 12. As the sensor, a piezoelectric sensor, an optical sensor, an electrostatic capacitance sensor, an ultrasonic wave sensor, and the like can be considered. The detailed configuration of the powder application apparatus 12 will be described later.

### [Liquid Ejection Apparatus]

The liquid ejection apparatus 22 is a liquid application apparatus that receives supply of the water-containing liquid from the liquid storage case 21 storing the water-containing liquid and applies the water-containing liquid on the hydrogen carrier on the conveyance belt 41. The liquid ejection apparatus 22 can adjust the amount of the water-containing liquid with respect to the amount of the hydrogen carrier. The liquid ejection apparatus 22 may eject the liquid onto the conveyance belt 41 in a contactless manner, or may eject the liquid in contact.

The liquid ejection apparatus 22 of a contactless type has no particular problem as long as the liquid ejection apparatus 22 is one that can apply the water-containing liquid on the hydrogen carrier such as a spray system, a shower system, or a dispenser system. Any of these systems can adjust the ejection amount of the liquid. In addition, as the liquid ejection apparatus 22 of a contact type, a gravure offset roller, a bar coater, a die coater, a blade coater, a knife coater, and the like can be mentioned. Any of these systems can adjust the ejection amount of the liquid.

In addition, the liquid storage case 21 serving as a liquid replenishment container stores the water-containing liquid to be supplied to the liquid ejection apparatus 22. The liquid storage case 21 is attachable to and detachable from the liquid ejection apparatus 22. That is, the liquid storage case 21 is replaceable.

### [Hydrogen Collection Apparatus]

The hydrogen collection apparatus 31 is provided for collecting the hydrogen generated by the reaction between the hydrogen carrier and the water-containing liquid. As illustrated in FIG. 1, it may be a canopy structure in a sense of an exhaustion apparatus, or may be one in which an upper outer wall of the hydrogen generation apparatus 1 has a slope shape and a discharge port is provided at the highest position. There is no particular problem as long as the structure collects the hydrogen generated inside the hydrogen generation apparatus 1. The hydrogen collection apparatus 31 of the present embodiment is disposed above the conveyance belt 41, and includes a collection portion 31a that collects the hydrogen generated on the conveyance belt 41, and a suction fan 31b that sucks the hydrogen collected by the collection portion 31a. The hydrogen sucked by the suction fan 31b is supplied to a supply destination such as a fuel cell through a pipe 31c.

In the fuel cell serving as one of supply destinations of hydrogen, dry hydrogen is desired. However, not only hydrogen but also a water vapor or a vapor of an alkaline substance generated by the reaction can mix into the collected gas. Therefore, it is preferable that a mechanism that removes substances other than a hydrogen gas, such as a filter containing water, a filter containing silica gel, or a steam trap incorporating a cooling apparatus, is provided in the flow path for hydrogen such as the pipe 31c.

### [Byproduct Collection Apparatus]

The byproduct collection apparatus 61 functions to remove the byproduct on the conveyance belt 41 from the conveyance belt 41 and send the byproduct to the byproduct collection case 62. The byproduct is, for example, sodium metaborate in the case where the hydrogen carrier is sodium borohydride. The byproduct collection apparatus 61 includes a collection blade 61a that comes into contact with the conveyance belt 41, and a blade holding member (illustration omitted) that holds the collection blade 61a.

The collection blade 61a preferably abuts the outer peripheral surface of the conveyance belt 41 stretched by a roller stretching the conveyance belt 41, which is the driving roller 42 in the present embodiment. In addition, the collection blade 61a preferably abuts a surface other than the surface 41a, such as the lower surface in the vertical direction or a side surface in the horizontal direction of the conveyance belt 41. In addition, the byproduct collection case 62 is preferably disposed below the collection blade 61a in the vertical direction. As a result of this, the byproduct collected by the collection blade 61a can be dropped by the gravity and collected by the byproduct collection case 62.

The material of the collection blade 61a is not particularly limited, and examples thereof include a rubber blade formed from rubber and used for cleaning of an intermediate transfer belt in a copier or the like. This is formed from rubber such as silicone rubber or urethane rubber, is molded into a plate shape, is attached such that the corner portion thereof is in contact in a counter direction with respect to the movement direction of the conveyance belt 41, and thus removes the byproduct on the conveyance belt 41. In addition, there is no problem in using one formed from metal or glass in a spatula shape, which is a so-called scraper, as the collection blade 61a.

The blade holding member has a function to support the collection blade 61a and apply a certain pressure to the collection blade 61a by using the warpage of the blade holding member. Although the material thereof is not particularly limited, metal is preferred because pressure is to be applied.

In addition, the byproduct collection case 62 serving as a collection container is a case for collecting the byproduct collected from the conveyance belt 41 by the collection blade 61a. The byproduct collection case 62 is attachable to and detachable from the byproduct collection apparatus 61. That is, the byproduct collection case 62 is replaceable.

### [Central Control Apparatus]

FIG. 2 is a block diagram illustrating a system of the hydrogen generation apparatus 1 of the present embodiment. A central control apparatus 101 includes a controller 112, a random access memory (RAM) 111, a storage 113 that stores a program, a communication interface, a signal transmitting portion 114, and a signal receiving portion 115. The controller 112 is constituted by a central processing unit (CPU) or a CPU and a read-only memory (ROM), and issues a control command to the whole hydrogen generation apparatus 1 by executing the program stored in the storage 113.

The RAM 111 is a main memory for work by the controller 112. The storage 113 is a storage region for storing a control program and the like, and the controller 112 performs processing by reading a control program, time-series data that is temporarily stored, log information, and the like from the RAM 111 and the storage 113.

Information from an external application 102 such as hydrogen application of the fuel cell to which the hydrogen generation apparatus 1 supplies or fuel cell application of a fuel cell vehicle (FCV) or the like that uses a fuel cell is input to the controller 112. In addition, the controller 112 receives information of an engine portion 103 of the hydrogen generation apparatus 1 through the signal receiving portion 115. As the information of the engine portion 103, a hydrogen amount detected by the flow rate sensor 32 provided in the hydrogen collection apparatus 31, information of remainder amount detection sensors 11a, 12a, and 22a provided in the hydrogen carrier storage case 11, the powder application apparatus 12, and the liquid ejection apparatus 22, and the like can be mentioned.

The remainder amount detection sensor 11a is a sensor that is provided in the hydrogen carrier storage case 11 and detects the remainder amount of the hydrogen carrier in the hydrogen carrier storage case 11. The remainder amount detection sensor 12a is a sensor that is provided in the powder application apparatus 12 and detects the remainder amount of the hydrogen carrier in the powder application apparatus 12. The remainder amount detection sensor 22a is a sensor that is provided in the liquid ejection apparatus 22, and detects the remainder amount of the water-containing liquid in the liquid ejection apparatus 22.

Further, the controller 112 transmits, as a signal generated in accordance with a control information set in advance, a replenishment signal to the hydrogen carrier storage case 11, a driving signal to the powder application apparatus 12 and the liquid ejection apparatus 22, a driving signal to the conveyance belt 41, and the like, via the signal transmitting portion 114.

The hydrogen carrier storage case 11 includes a driving portion 11b for replenishing the powder application apparatus 12 with the hydrogen carrier. The powder application apparatus 12 includes a driving portion 12b for applying the hydrogen carrier on the conveyance belt 41. The liquid ejection apparatus 22 includes a driving portion 22b for ejecting the liquid onto the hydrogen carrier on the conveyance belt 41. In addition, the conveyance belt 41 is driven by the driving portion 41b as described above. The controller 112 controls the drive of the driving portions 11b, 12b, 22b, and 41b.

Specifically, the driving portion 11b of the hydrogen carrier storage case 11 is, for example, a motor or a solenoid that drives a shutter provided at a connecting portion between the hydrogen carrier storage case 11 and the powder application apparatus 12. The controller 112 performs and stops the replenishment operation of the hydrogen carrier from the hydrogen carrier storage case 11 to the powder application apparatus 12 by, for example, driving the driving portion 11b to open and close the shutter.

The driving portion 12b of the powder application apparatus 12 is, for example, a motor that drives a roller for applying the hydrogen carrier on the conveyance belt 41. The controller 112 drives the driving portion 12b to control the drive of the roller, and thus performs and stops the application operation of the hydrogen carrier from the powder application apparatus 12 to the surface 41a of the conveyance belt 41.

The driving portion 22b of the liquid ejection apparatus 22 is, for example, provided to eject the liquid onto the conveyance belt 41, and the driving configuration thereof differs depending on the system thereof. The controller 112 controls the drive of the driving portion 22b, and thus performs and stops the liquid ejection operation from the liquid ejection apparatus 22 to the surface 41a of the conveyance belt 41.

The driving portion 41b of the conveyance belt 41 is, for example, a motor as described above. The controller 112 controls the drive of the driving portion 41b, and thus drives and stops the conveyance belt 41, and further controls the driving speed thereof.

### [Regulation of Thickness of Hydrogen Carrier]

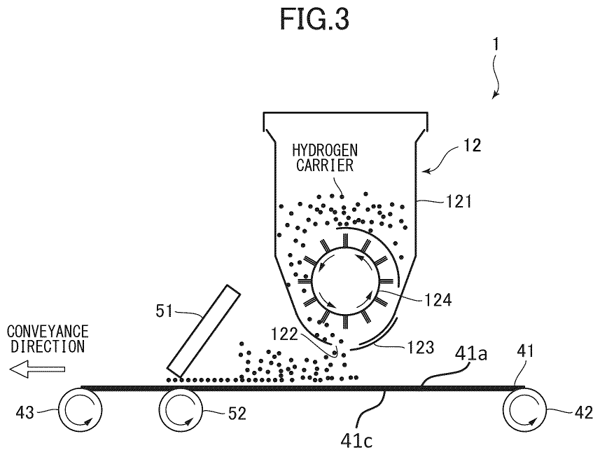

Next, regulation of the thickness of the hydrogen carrier applied on the conveyance belt 41 by the powder application apparatus 12 of the present embodiment will be described by using FIG. 3. In the case where the hydrogen carrier applied on the conveyance belt 41 by the powder application apparatus 12 as described above is uneven in terms of thickness, the reaction speed with the water-containing liquid on the belt becomes uneven, and there is a possibility that the hydrogen carrier is conveyed downstream although the hydrolysis reaction has not progressed sufficiently. Then, there is a possibility that the unreacted hydrogen carrier is mixed into the byproduct collection apparatus 61. As a demerit of the reaction not progressing sufficiently, the amount of hydrogen that can be collected decreasing to lower the energy efficiency, the unreacted hydrogen carrier mixing into the byproduct collection apparatus 61 to fill the byproduct collection apparatus 61 with hydrogen, and the like can be mentioned.

In view of such a problem, the hydrogen generation apparatus 1 of the present embodiment includes a regulation member 51 to uniformize the thickness of the hydrogen carrier applied on the conveyance belt 41. In the present embodiment, the regulation member 51 regulates the thickness of the hydrogen carrier applied on the surface 41a of the conveyance belt 41 by the powder application apparatus 12. First, the detailed configuration of the powder application apparatus 12 of the present embodiment will be described.

### [Detailed Configuration of Powder Application Apparatus]

As illustrated in FIG. 3, the powder application apparatus 12 is disposed above the surface 41a of the conveyance belt 41 in the gravity direction, and includes a storage portion 121, an opening portion 122, a shutter 123, and a brush roller 124. The storage portion 121 stores the hydrogen carrier. The opening portion 122 is formed such that the hydrogen carrier in the storage portion can be supplied onto the surface 41a of the conveyance belt 41 by gravity, and is formed at a lower end portion of the storage portion 121 in the present embodiment. The shutter 123 is capable of opening and closing the opening portion 122. The shutter 123 is driven by an unillustrated driving portion such as a motor or a solenoid, and opens and closes the opening portion 122 in response to the driving portion being controlled by an instruction from the controller 112 (see FIG. 2).

The brush roller 124 serving as an assistance member is an assistance roller that assists the supply of the hydrogen carrier from the opening portion 122 onto the surface 41a of the conveyance belt 41. The brush roller 124 is disposed in the storage portion 121 at a position near the opening portion 122. The brush roller 124 is driven by an unillustrated driving portion such as a motor, and rotates and stops in response to the driving portion being controlled by an instruction from the controller 112 (see FIG. 2). To be noted, the assistance member that assists the supply of the hydrogen carrier may be one capable of assisting the supply of the hydrogen carrier such as a paddle or a screw fin instead of a roller.

The storage portion 121 of the powder application apparatus 12 configured in this manner is filled with a certain amount of hydrogen carrier, and the hydrogen carrier is dropped down in the gravity direction by opening the shutter 123 provided in a lower portion thereof when generating hydrogen. At this time, the brush roller 124 is rotationally driven, and thus assists the supply of the hydrogen carrier in the storage portion 121 toward the opening portion 122 with the shutter 123 being open. The hydrogen carrier having fallen onto the conveyance belt 41 from the opening portion 122 reaches the surface 41a of the conveyance belt 41. The conveyance belt 41 is driven like a belt conveyor by the driving roller 42 as described above.

In this manner, the hydrogen carrier is supplied to the surface 41a of the conveyance belt 41 by the powder application apparatus 12. In the hydrogen generation apparatus 1, the storage portion 121 is provided with a remainder amount detection sensor 12a (see FIG. 2), and the operation is performed while supplying the hydrogen carrier to the powder application apparatus 12 from the hydrogen carrier storage case 11 (see FIG. 1) on the basis of information such as a detection signal of the remainder amount detection sensor 12a.

### [Regulation Member]

The hydrogen generation apparatus 1 of the present embodiment is provided with the regulation member 51 to uniformize the layer thickness of the hydrogen carrier on the conveyance belt 41 in the in-plane direction as described above. The regulation member 51 is disposed to oppose the surface 41a of the conveyance belt 41 with a predetermined gap therebetween or be in contact with the surface 41a, and regulates the thickness of the hydrogen carrier applied on the surface 41a from the powder application apparatus 12.

Specifically, the regulation member 51 is disposed to oppose the conveyance belt 41 at a position downstream of the powder application apparatus 12 in the rotational direction of the conveyance belt 41 (conveyance direction of the hydrogen carrier). The regulation member 51 is, for example, a blade member formed in a plate shape, and is disposed such that the longitudinal direction thereof is approximately parallel to the width direction of the conveyance belt 41 intersecting with (orthogonal to in the present embodiment) the rotational direction of the conveyance belt 41.

As the material of the regulation member 51, elastic materials such as silicone rubber and urethane rubber, metal materials such as stainless steel (SUS), and the like can be mentioned. The regulation member 51 is preferably a member formed from metal to strictly define the gap amount in the case of providing the predetermined gap between the regulation member 51 and the conveyance belt 41, and is preferably a member formed from rubber in the case of coming into contact with the conveyance belt 41.

In the present embodiment, the regulation member 51 is formed from stainless steel (SUS), and a constant gap is provided between the regulation member 51 and the conveyance belt 41 in the width direction of the conveyance belt 41. In addition, a backup roller 52 serving as a support roller is disposed on a back surface (inner peripheral surface) 41c of the conveyance belt 41 at a position opposing the regulation member 51 with the conveyance belt 41 therebetween. The backup roller 52 abuts the back surface 41c, and supports the back surface 41c of the conveyance belt 41 at a position where the surface 41a opposes the regulation member 51. The backup roller 52 can reduce the influence of warpage of the conveyance belt 41, and thus secure the width of the gap between the regulation member 51 and the conveyance belt 41.

In the present embodiment, the width of the gap between the regulation member 51 and the conveyance belt 41 is set to 300 μm. By setting the width of the gap as several times as large as the particle diameter of the hydrogen carrier, the hydrogen carrier on the conveyance belt 41 can be uniformly spread to, for example, about three layers, and the reaction can be uniformly progressed.

As described above, in the case of the present embodiment, the thickness of the hydrogen carrier applied on the conveyance belt 41 is regulated by the regulation member 51, thus the thickness of the hydrogen carrier applied on the conveyance belt 41 can be uniformized, and unevenness in the progress of the reaction caused by the supply of the liquid to the hydrogen carrier can be suppressed. As a result of this, the reaction between the hydrogen carrier and the water-containing liquid can be easily promoted on the conveyance belt 41.

### Second Embodiment

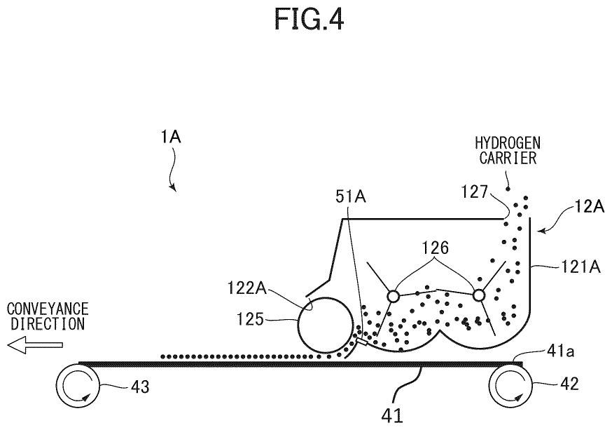

A second embodiment will be described by using FIG. 4. A hydrogen generation apparatus 1A of the present embodiment is different from the first embodiment in the configuration for regulating the thickness of the hydrogen carrier on the conveyance belt 41. The other elements and functions are similar to those of the first embodiment described above, and therefore similar elements are denoted by the same reference signs, description and illustration thereof are omitted or simplified, and part different from the first embodiment will be mainly described.

In the case of the present embodiment, a regulation member 51A that regulates the thickness of the hydrogen carrier is provided in a powder application apparatus 12A. That is, the powder application apparatus 12A of the present embodiment includes a storage portion 121A, an opening portion 122A, a supply roller 125, the regulation member 51A serving as a roller-side regulation member, and paddles 126 serving as agitation conveyance members. The storage portion 121A stores the hydrogen carrier. The opening portion 122A is formed such that the hydrogen carrier in the storage portion can be supplied onto the surface 41a of the conveyance belt 41 by the supply roller 125, and is formed on the lower end side of the storage portion 121A in the present embodiment.

The supply roller 125 is a roller that bears the hydrogen carrier and supplies the hydrogen carrier onto the surface 41a of the conveyance belt 41, and is disposed such that part thereof is exposed through the opening portion 122A in the present embodiment. The supply roller 125 is disposed such that the rotational axis direction thereof is approximately parallel to the width direction of the conveyance belt 41, and the surface thereof opposing the conveyance belt 41 rotates in the same direction as the rotational direction of the conveyance belt 41, that is, in a forward direction.

The regulation member 51A regulates the thickness of the hydrogen carrier borne on the supply roller 125. That is, the regulation member 51A is disposed to oppose the surface of the supply roller 125 with a predetermined gap therebetween or be in contact with the surface of the supply roller 125, and regulates the thickness of the hydrogen carrier borne on the supply roller 125. The paddles 126 convey the hydrogen carrier in the storage portion toward the supply roller 125 while agitating the hydrogen carrier.

In the storage portion 121A of the present embodiment, a supply port 127 through which the hydrogen carrier is supplied thereto from the hydrogen carrier storage case 11 (see FIG. 1) and the opening portion 122A are arranged at positions away from each other as illustrated in FIG. 4. Therefore, a plurality of (two in the present embodiment) paddles 126 are provided such that the hydrogen carrier supplied from the hydrogen carrier storage case 11 to the supply port 127 can be conveyed to the supply roller 125.

The supply roller 125 and the paddles 126 are driven by an unillustrated driving portion such as a motor, and rotate and stop in response to the driving portion being controlled by an instruction from the controller 112 (see FIG. 2). The regulation member 51A has a certain gap from the supply roller 125 in the longitudinal direction (rotational axis direction) of the supply roller 125.

In addition, as the material of the regulation member 51A, elastic materials such as silicone rubber and urethane rubber, metal materials such as stainless steel (SUS), and the like can be mentioned. The regulation member 51A is preferably a member formed from metal to strictly define the gap amount in the case of providing the predetermined gap between the regulation member 51A and the supply roller 125, and is preferably a member formed from rubber in the case of coming into contact with the supply roller 125.

In the case of the present embodiment, the hydrogen carrier is delivered onto the conveyance belt 41 as a result of the rotation of the supply roller 125 provided at the opening portion 122A of the powder application apparatus 12A. A constant gap of 300 μm is provided between the surface of the supply roller 125 and the regulation member 51A, and the hydrogen carrier having passed through this is supplied onto the conveyance belt 41 at a constant amount in the longitudinal direction of the supply roller 125.

In the present embodiment, to prevent packing of the hydrogen carrier in the vicinity of the regulation member 51A, the hydrogen carrier powder is agitated constantly while sending the hydrogen carrier to the vicinity of the regulation member 51A by the paddles 126 installed inside the powder application apparatus 12A instead of employing the configuration in which the hydrogen carrier is dropped in the gravity direction as in the first embodiment.

In the case of the present embodiment configured in this manner, since the application on the conveyance belt 41 is performed after the thickness of the hydrogen carrier borne on the supply roller 125 is regulated by the regulation member 51A, the hydrogen carrier is applied on the conveyance belt 41 in a state in which the thickness thereof is regulated. As a result of this, the thickness of the hydrogen carrier applied on the conveyance belt 41 can be uniformized, and occurrence of unevenness in the progress of the reaction caused by the supply of the liquid to the hydrogen carrier can be suppressed. As a result of this, the reaction between the hydrogen carrier and the water-containing liquid can be easily promoted on the conveyance belt 41.

### Third Embodiment

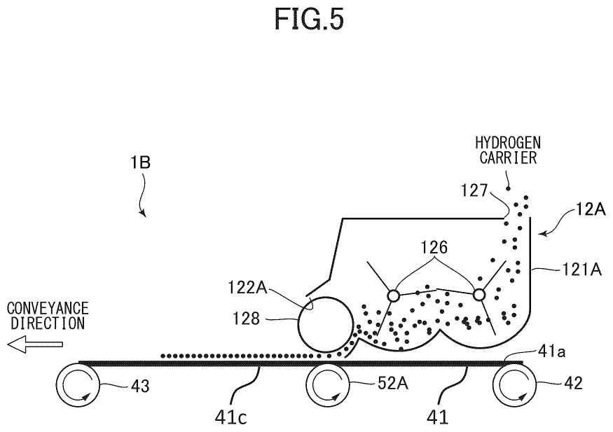

A third embodiment will be described by using FIG. 5. A hydrogen generation apparatus 1B of the present embodiment is different from the second embodiment in the configuration for regulating the thickness of the hydrogen carrier on the conveyance belt 41. The other elements and functions are similar to those of the second embodiment described above, and therefore similar elements are denoted by the same reference signs, description and illustration thereof are omitted or simplified, and part different from the second embodiment will be mainly described.

In the present embodiment, a supply regulation roller 128 of a powder application apparatus 12B plays the role for the supply of the hydrogen carrier onto the conveyance belt 41 and the regulation of the amount of supplied hydrogen carrier. That is, the powder application apparatus 12B includes the supply regulation roller 128 serving as a supply roller that bears the hydrogen carrier and supplies the hydrogen carrier onto the surface 41a of the conveyance belt 41. The supply regulation roller 128 is disposed to oppose the surface 41a of the conveyance belt 41 with a predetermined gap therebetween or be in contact with the surface 41a, and regulates the thickness of the hydrogen carrier applied on the surface 41a while supplying the hydrogen carrier onto the surface 41a. The other elements related to the powder application apparatus 12B are similar to those of the second embodiment.

The supply regulation roller 128 is disposed such that part thereof is exposed through the opening portion 122A. In addition, the supply regulation roller 128 is disposed such that the rotational axis direction thereof is approximately parallel to the width direction of the conveyance belt 41, and the surface thereof opposing the conveyance belt 41 rotates in the same direction as the rotational direction of the conveyance belt 41, that is, in a forward direction.

The supply regulation roller 128 and the paddles 126 are driven by an unillustrated driving portion such as a motor, and rotate and stop in response to the driving portion being controlled by an instruction from the controller 112 (see FIG. 2). The supply regulation roller 128 has a constant gap from the conveyance belt 41 in the longitudinal direction (rotational axis direction) of the supply regulation roller 128.

As the material of the supply regulation roller 128, elastic materials such as silicone rubber and urethane rubber, metal materials such as stainless steel (SUS), and the like can be mentioned. The supply regulation roller 128 is preferably a member formed from metal to strictly define the gap amount in the case of providing the predetermined gap between the supply regulation roller 128 and the conveyance belt 41, and is preferably a member formed from rubber in the case of coming into contact with the conveyance belt 41.

In addition, a backup roller 52A serving as a support roller is disposed on the back surface (inner peripheral surface) 41c of the conveyance belt 41 at a position opposing the supply regulation roller 128 with the conveyance belt 41 therebetween. The backup roller 52A abuts the back surface 41c, and supports the back surface 41c of the conveyance belt 41 at a position where the surface 41a opposes the supply regulation roller 128. The backup roller 52 can reduce the influence of warpage of the conveyance belt 41, and thus secure the width of the gap between the supply regulation roller 128 and the conveyance belt 41.

In the case of the present embodiment, the supply regulation roller 128 provided at the opening portion 122A of the powder application apparatus 12B rotates to deliver the hydrogen carrier onto the conveyance belt 41. The width of the gap between the surface of the supply regulation roller 128 and the conveyance belt 41 is set to 300 μm.

In the case of the present embodiment configured in this manner, since the thickness of the hydrogen carrier is regulated while supplying the hydrogen carrier onto the conveyance belt 41 by the supply regulation roller 128, the thickness of the hydrogen carrier applied on the conveyance belt 41 can be uniformized, and occurrence of unevenness in the progress of the reaction caused by the supply of the liquid to the hydrogen carrier can be suppressed. As a result of this, the reaction between the hydrogen carrier and the water-containing liquid can be easily promoted on the conveyance belt 41.

### OTHER EMBODIMENTS

A configuration in which the regulation member 51 or 51A or the supply regulation roller 128 opposes the conveyance belt 41 or the supply roller 125 with a predetermined gap therebetween has been described in the first to third embodiments described above. However, a configuration in which the regulation member 51 or 51A or the supply regulation roller 128 is configured as a blade or a roller formed from an elastic member such as rubber and configured to come into contact with the conveyance belt 41 or the supply roller 125 may be employed. In this case, the passage amount of the hydrogen carrier powder changes in accordance with the contact pressure between the elastic member and the conveyance belt 41 or the supply roller 125. Therefore, the thickness of the hydrogen carrier can be uniformized by managing the contact pressure in the longitudinal direction to be constant.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A hydrogen generation apparatus comprising:
a conveyance belt;
an application apparatus configured to apply a solid hydrogen carrier on a surface of the conveyance belt;
an ejection apparatus configured to eject a liquid containing water onto the hydrogen carrier applied on the surface of the conveyance belt;
a hydrogen collection apparatus configured to collect hydrogen generated by a reaction between the hydrogen carrier and the liquid on the surface of the conveyance belt;
a byproduct collection apparatus configured to collect a byproduct generated by the reaction between the hydrogen carrier and the liquid on the surface of the conveyance belt; and
a regulation member for regulating a thickness of the hydrogen carrier applied on the surface of the conveyance belt by the application apparatus.

2. The hydrogen generation apparatus according to claim 1, wherein the regulation member is disposed to oppose the surface of the conveyance belt with a predetermined gap therebetween or be in contact with the surface, and regulates the thickness of the hydrogen carrier applied on the surface from the application apparatus.

3. The hydrogen generation apparatus according to claim 2, further comprising a support roller disposed to abut a back surface of the conveyance belt at a position opposing the regulation member with the conveyance belt therebetween and configured to support the back surface of the conveyance belt.

4. The hydrogen generation apparatus according to claim 1, wherein the application apparatus is disposed above the surface of the conveyance belt in a gravity direction, and includes a storage portion configured to store the hydrogen carrier, an opening portion capable of supplying the hydrogen carrier in the storage portion onto the surface of the conveyance belt by gravity, a shutter capable of opening and closing the opening portion, and an assistance member configured to assist supply of the hydrogen carrier from the opening portion onto the surface of the conveyance belt.

5. A hydrogen generation apparatus comprising:
a conveyance belt;
an application apparatus configured to apply a solid hydrogen carrier on a surface of the conveyance belt;
an ejection apparatus configured to eject a liquid containing water onto the hydrogen carrier applied on the surface of the conveyance belt;
a hydrogen collection apparatus configured to collect hydrogen generated by a reaction between the hydrogen carrier and the liquid on the surface of the conveyance belt; and
a byproduct collection apparatus configured to collect a byproduct generated by the reaction between the hydrogen carrier and the liquid on the surface of the conveyance belt,
wherein the application apparatus includes a supply roller configured to bear the hydrogen carrier and supply the hydrogen carrier onto the surface of the conveyance belt, and a roller-side regulation member configured to regulate a thickness of the hydrogen carrier borne on the supply roller.

6. The hydrogen generation apparatus according to claim 5, wherein the roller-side regulation member is disposed to oppose a surface of the supply roller with a predetermined gap therebetween or be in contact with the surface of the supply roller, and regulates the thickness of the hydrogen carrier borne on the supply roller.

7. The hydrogen generation apparatus according to claim 6, wherein the application apparatus includes a storage portion configured to store the hydrogen carrier, an opening portion capable of supplying the hydrogen carrier in the storage portion onto the surface of the conveyance belt by the supply roller, and an agitation conveyance member configured to convey the hydrogen carrier in the storage portion toward the supply roller while agitating the hydrogen carrier.

8. A hydrogen generation apparatus comprising:
a conveyance belt;
an application apparatus configured to apply a solid hydrogen carrier on a surface of the conveyance belt;
an ejection apparatus configured to eject a liquid containing water onto the hydrogen carrier applied on the surface of the conveyance belt;
a hydrogen collection apparatus configured to collect hydrogen generated by a reaction between the hydrogen carrier and the liquid on the surface of the conveyance belt; and
a byproduct collection apparatus configured to collect a byproduct generated by the reaction between the hydrogen carrier and the liquid on the surface of the conveyance belt,
wherein the application apparatus includes a supply roller configured to bear the hydrogen carrier and supply the hydrogen carrier onto the surface of the conveyance belt, and
wherein the supply roller is disposed to oppose the surface of the conveyance belt with a predetermined gap therebetween or be in contact with the surface, and regulates a thickness of the hydrogen carrier applied on the surface while supplying the hydrogen carrier onto the surface.

9. The hydrogen generation apparatus according to claim 8, further comprising a support roller disposed abut with a back surface of the conveyance belt at a position opposing the supply roller with the conveyance belt therebetween and configured to support the back surface of the conveyance belt.

10. The hydrogen generation apparatus according to claim 8, wherein the application apparatus includes a storage portion configured to store the hydrogen carrier, an opening portion capable of supplying the hydrogen carrier in the storage portion onto the surface of the conveyance belt by the supply roller, and an agitation conveyance member configured to convey the hydrogen carrier in the storage portion toward the supply roller while agitating the hydrogen carrier.

11. The hydrogen generation apparatus according to claim 1, further comprising:
a hydrogen carrier replenishment container configured to store the hydrogen carrier for replenishing the application apparatus with the hydrogen carrier,
wherein the hydrogen carrier replenishment container is replaceable.

12. The hydrogen generation apparatus according to claim 5, further comprising:
a hydrogen carrier replenishment container configured to store the hydrogen carrier for replenishing the application apparatus with the hydrogen carrier,
wherein the hydrogen carrier replenishment container is replaceable.

13. The hydrogen generation apparatus according to claim 8, further comprising:
a hydrogen carrier replenishment container configured to store the hydrogen carrier for replenishing the application apparatus with the hydrogen carrier,
wherein the hydrogen carrier replenishment container is replaceable.
